(19) United States
(12) Patent Application Publication
(10) Pub. No.: US 2006/0277352 A1
(43) Pub. Date: Dec. 7, 2006

(54) Method and system for supporting large caches with split and canonicalization tags

(76) Inventor: Fong Pong, Mountain View, CA (US)

Correspondence Address: MCANDREWS HELD & MALLOY, LTD, 500 WEST MADISON STREET, SUITE 3400, CHICAGO, IL, 60661, US

(21) Appl. No.: 11/228,163

(22) Filed: Sep. 16, 2005

Related U.S. Application Data
(60) Provisional application No. 60/688,813, filed on Jun. 7, 2005.

(51) Int. Cl. G06F 12/00

(52) U.S. Cl. 711/3; 711/118

(57) ABSTRACT

Aspects of a method and system for supporting large caches with split and canonicalization tags are presented. One aspect of the system may comprise a processor that generates a canonicalization tag based on at least a current portion of a tag field of a physical address. A tag cache line may be retrieved based on a set field of the physical address. The processor may compare the canonicalization tag and at least a portion of the retrieved tag cache line. Based on the comparison between the canonicalization tag and at least a portion of the retrieved tag cache line, the processor may retrieve a data cache line from cache memory.

### CROSS-REFERENCE TO RELATED APPLICATIONS/INCORPORATION BY REFERENCE

This application makes reference, claims priority to, and claims the benefit of U.S. Provisional Application Ser. No. 60/688,813 filed Jun. 7, 2005.

The application makes reference to:
U.S. application Ser. No. ______ (Attorney Docket No. 16591US02) filed Sep. 16, 2005;
U.S. application Ser. No. ______ (Attorney Docket No. 16669US01) filed Sep. 16, 2005;
U.S. application Ser. No. ______ (Attorney Docket No. 16592US02) filed Sep. 16, 2005;
U.S. application Ser. No. ______ (Attorney Docket No. 16593US02) filed Sep. 16, 2005;
U.S. application Ser. No. ______ (Attorney Docket No. 16594US02) filed Sep. 16, 2005; and
U.S. application Ser. No. ______ (Attorney Docket No. 16642US02) filed Sep. 16, 2005.

All of the above stated applications are hereby incorporated herein by reference in their entirety.

### FIELD OF THE INVENTION

Certain embodiments of the invention relate to data processing. More specifically, certain embodiments of the invention relate to a method and system for supporting large caches with split and canonicalization tags.

### BACKGROUND OF THE INVENTION

Many devices in common usage comprise a central processing unit (CPU), or processor, and/or system memory. The CPU may control some aspect of the operation of the device. The CPU may comprise a processor core and ancillary circuitry. The operation of the processor may be controlled based upon applications programs or code and/or data. At least a portion of the code and/or data may be stored within system memory. During operation, the CPU may retrieve at least a portion of the code and/or data from system memory, causing the CPU to perform steps that control some aspect of the operation of the device. A time interval that comprises a time instant at which the processor issues an instruction to retrieve a portion of code and/or data from system memory and a subsequent time instant at which the portion of code is received by the processor may be referred to as latency. A quantity of code and/or data, as measured in binary bytes for example, that may be retrieved from system memory per unit time may be referred to as a data transfer rate. Latency and/or data transfer rate parameters may be among a plurality of factors that may determine the performance of processors that control some aspect of the operation of a device. Improvements that reduce latency and/or increase data transfer rate, for example, may improve the performance of processors that utilize code and/or data stored within system memory.

One approach may be to utilize cache memory. Cache memory may comprise memory characterized by reduced latency and/or increased data transfer rate when compared to other system memory technologies, for example dynamic random access memory (DRAM). As such, cache memory, also referred to as a cache, may be described as being “faster” than DRAM. The performance of the processor may depend, in part, upon cache performance. The performance of the processor may be reduced if code and/or data are not stored in the cache but is, instead, stored within DRAM, for example.

Some processors which operate at high speeds, for example, as measured by clock cycle rates greater than 1 giga Hertz (GHz), may implement a cache hierarchy. A cache hierarchy may comprise a segmentation of the cache into distinct physical groupings, for example, wherein the characteristics of the cache in one level of the hierarchy may differ from the characteristics of the cache in another level of the hierarchy. The first level (L1) cache may be small in size in comparison to other levels in the cache hierarchy, where size may be measured in binary bytes, for example, and may run at a speed that is about equal to that of the processor core. Latency during accesses from the second level (L2) cache may be in the order of 12 or 13 processor clock cycles. Subsequently, a processor may utilize a much larger, but slower third level (L3) cache in addition to the smaller L1 and L2 caches. The L1 and/or L2 caches may be located within the processor. The L3 cache may be located externally from the CPU.

In some cache architectures, data may be stored within the L3 cache, while a corresponding “tag” may be stored within cache that is located within the processor. The tag may comprise information that may be utilized by the processor to locate corresponding data that is stored in the L3 cache. An issue facing the designers of processors is a trend toward an increase in a size of memory required to store tags.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for supporting large caches with split and canonicalization tags, substantially as shown in and/or described in connection with at least one of the figures, and set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of an exemplary system that may be utilized in connection with an embodiment of the invention.

FIG. 1b is a block diagram of an exemplary system for handling out-of-order (OOO) transmission control protocol (TCP) datagrams in a flow through manner, which may be utilized in connection with an embodiment of the invention.

FIG. 2 is a block diagram of an exemplary processor system comprising cache memory, which may be utilized in connection with an embodiment of the invention.

FIG. 3a is a block diagram illustrating an exemplary address structure for addressing data stored in L3 cache memory that may be utilized in connection with an embodiment of the invention.

FIG. 3b is a block diagram illustrating an exemplary address structure for addressing data stored in L2 cache memory that may be utilized in connection with an embodiment of the invention.

FIG. 4 is a block diagram illustrating an exemplary system for supporting large caches with split and canonicalization tags, in accordance with an embodiment of the invention.

FIG. 5a is a block diagram illustrating an exemplary method for addressing supporting large caches with split and canonicalization tags, in accordance with an embodiment of the invention.

FIG. 5b is a block diagram illustrating an exemplary cache write-back operation, in accordance with an embodiment of the invention.

FIG. 6 is a flowchart that illustrates exemplary steps by which a cache line may be written, in accordance with an embodiment of the invention.

FIG. 7 is a flowchart that illustrates exemplary steps by which a cache line maybe read, in accordance with an embodiment of the invention.

### DETAILED DESCRIPTION OF THE INVENTION

Certain embodiments of the invention may be found in a method and system for supporting large caches with split and canonicalization tags.

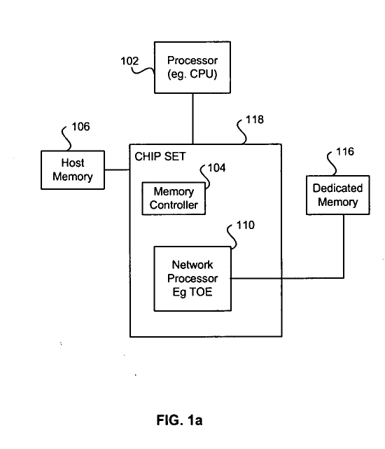

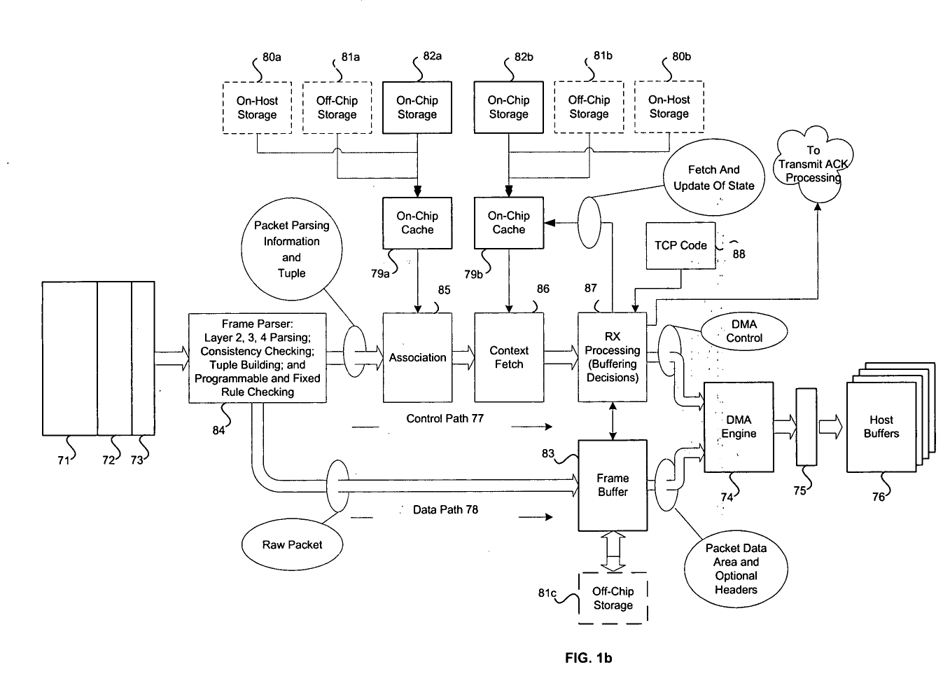

FIG. 1a is a block diagram of an exemplary system that may be utilized in connection with an embodiment of the invention. Referring to FIG. 1a, the system may include, for example, a processor 102, a host memory 106, a dedicated memory 116 and a chip set 118. The chip set 118 may comprise, for example, the wireless network processor 110. The chip set 118 may be coupled to the CPU 102, to the host memory 106, and to the dedicated memory 116. The wireless network processor 110 of the chip set 118 may comprise a TOE. The dedicated memory 116 may provide buffers for context and/or data. The exemplary system illustrated in FIG. 1a may be utilized in a plurality of applications. For example, the system illustrated in FIG. 1a may be utilized in an embodiment of a network interface card (NIC).

FIG. 1b is a block diagram of an exemplary system for handling out-of-order (OOO) transmission control protocol (TCP) datagrams in a flow-through manner, which may be utilized in connection with an embodiment of the invention. Referring to FIG. 1b, there is shown a physical (PHY) block 71, medium access control (MAC) block 72, CRC block 73, a DMA engine 74, a host bus 75, host buffer block 76, control path 77, data path 78, frame buffer 83, and frame parser block 84. FIG. 1b further comprises a plurality of memory options including on chip cache block 79a, 79b, on-host storage block 80a, 80b, off-chip storage 81a, 81b, 81c and on-chip storage 82a, 82b.

In general, incoming frames may be subject to layer 2 processing including, for example, address filtering, frame validity and error detection. An incoming frame, after being processed by the PHY 71, MAC 72 and CRC block 73, may be communicated to the frame parser block 84 for parsing. The frame parsing block 84 may be adapted to parse control information and actual payload data from a frame. The frame parsing block 84 may be adapted to facilitate parsing of layer 2, layer 3 or layer 4 header information, consistency checking, tuple lookup, and programmable and fixed rule checking. After frame parsing block 84 has completed parsing, resulting control information may be communicated via a control path 77 for processing and payload data and/or raw packet data may be communicated via a data path 78 for processing. The raw packet data may comprise optional header information. The parsed payload packet data may be buffered in the frame buffer block. At least a portion of the parsed payload packet may be stored in an off-chip storage block such as the off-chip storage block 81c. In this regard, raw packet information and/or payload data may be moved in and out of the frame buffer to the off-chip storage. The DMA engine 74 may move DMA data out of the frame buffer into buffers in the host buffer block 76.

The next stage of processing may include, for example, layer 3 such as IP processing and layer 4 such as TCP processing. The network processor 110 may reduce the host CPU utilization and memory bandwidth, for example, by processing traffic on hardware offloaded TCP/IP connections. The network processor 110 may detect, for example, the protocol to which incoming packets belong. For TCP, the network processor 110 may detect whether the packet corresponds to an offloaded TCP connection, for example, a connection for which at least some TCP state information may be kept by the network processor 110. Once a connection has been associated with a packet or frame, any higher level of processing such as layer 5 or above may be achieved. If the packet corresponds to an offloaded connection, then the network processor 110 may direct data movement of the data payload portion of the frame. The destination of the payload data may be determined from the connection state information in combination with direction information within the frame. The destination may be a host memory, for example. Finally, the network processor 110 may update its internal TCP and higher levels of connection state and may obtain the host buffer address and length from its internal connection state.

The system components in the control path 77 may be utilized to handle various processing stages used to complete, for example, the layer 3, layer 4 or higher processing with maximal flexibility and efficiency. These components may include the association block 85, context fetch block 86, receive (Rx) processing block 87, TCP code 88, and the cache and storage blocks. One or more of the association block 85, context fetch block 86, receive processing block 87, or TCP code 88 may comprise an on-chip processor. The result of the stages of processing may include, for example, one or more packet identification cards (PID_Cs) that may provide a control structure that may carry information associated with the frame payload data. This may have been generated inside the network processor 110 while processing the packet in the various blocks. The receive processing block 87 may comprise suitable logic, circuitry and/or code that may be adapted to generate buffer control information that may be utilized to control the DMA engine 74.

After the frame parser block 84 parses the TCP/IP headers from an incoming frame, the association block 85 may associate the frame with an end-to-end TCP/IP connection. The context fetch block 86 may be adapted to fetch the TCP connection context and processing the TCP/IP headers. Header and/or data boundaries may be determined and data may be mapped to one or more host buffer(s) in the host buffer block 76. The DMA engine 74 may be adapted to DMA transfer the data into the buffers in the host buffer block 76 via the host bus 75. The headers may be consumed on chip or transferred to the host via the DMA engine.

The frame buffer 83 may be an optional block in the receive system architecture. It may be utilized for the same purpose as, for example, a first-in-first-out (FIFO) data structure is used in a conventional layer 2 NIC or for storing higher layer traffic for additional processing. The frame buffer 83 in the receive system may not be limited to a single instance and accordingly, there may be multiple instances of the frame buffer block 83. A single FIFO may be utilized for multiple connections. As control path 77 handles the processing of parsed control information, the data path 78 may store corresponding data between data processing stages one or more times depending, for example, on protocol requirements. Various embodiments of the invention may not be limited to TCP and/or IP processing, but may be utilized in a plurality of systems and/or applications.

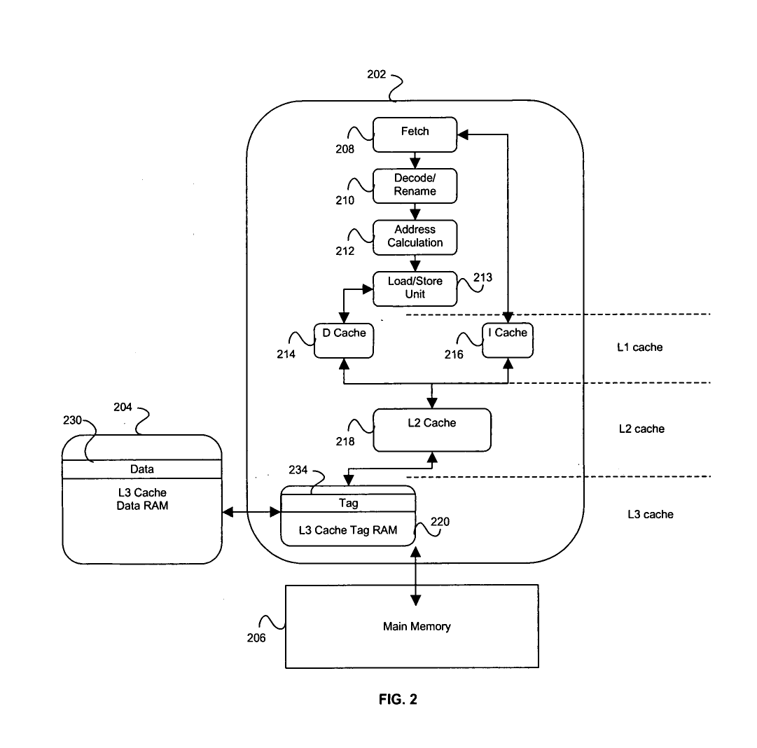

FIG. 2 is a block diagram of an exemplary processor system comprising cache memory, which may be utilized in connection with an embodiment of the invention. Referring to FIG. 2 there is shown a processor integrated circuit (IC) 202, an L3 cache data RAM 204, and main memory 206. The processor IC 202, or processor, may comprise a fetch block 208, a decode and rename block 210, an address calculation block 212, a load and store block 213, a data (D) cache 214, an instruction (I) cache 216, an L2 cache 218, and an L3 cache tag RAM 220. The L3 cache tag RAM 220 may store a plurality of tag sets 234. The tag set 234 may comprise a plurality of addresses that may be utilized to retrieve or store data 230 within the L3 cache data RAM 204. The L3 cache data RAM 204 may store a plurality of data 230. The D cache 214, and the I cache 216 may form constituent components in an L1 cache. The L3 cache tag RAM 220 and the L3 cache data RAM 204 be components in an L3 cache. The L1 cache, L2 cache, and/or L3 cache may individually or collectively be referred to as cache memory. The data 230 may comprise a cache line.

The L3 cache data RAM 204 may comprise suitable logic, and/or circuitry that may be configured to store data. The L3 cache data RAM 204 may comprise a plurality of integrated circuits, utilizing SRAM technology for example, that may be located externally from the processor integrated circuit 202. An integrated circuit may also be referred to as a chip. The main memory 206 may comprise suitable logic, and/or circuitry that may be configured to store data. The main memory 206 may comprise a plurality of integrated circuits, utilizing for example DRAM technology, which may be located externally from the processor integrated circuit. The L3 cache tag RAM 220 may comprise suitable logic, and/or circuitry that may be adapted to store a plurality of tag sets 234, each comprising one or more address fields that may be utilized to read data from, or write data to, an addressed location within the L3 cache data RAM 204, and/or within the main memory 206. The address field may be referred to as a tag field. The L3 cache tag RAM 220 may be located internally within the processor IC 202. The L3 cache tag RAM 220 may comprise a plurality of tags sets 234. For each tag within the tag set 234, there may be a corresponding cache line within the L3 cache data RAM 204. Limitations in the physical dimensions of the processor IC 202, may impose limitations on the size of the L3 cache tag RAM 220. Limitations on the size of the L3 cache tag RAM 220 may impose limitations on the number of tag fields within the L3 cache tag RAM 220. Limitations on the number of tag fields within the L3 cache tag RAM 220 may impose limitations on the number of cache lines within the L3 cache data RAM 204.

The fetch block 208 may retrieve or store one or more lines of executable code that is stored in the I cache 216. The decode and rename block 210 may receive an instruction from the fetch block 208. The decode and rename block 210 may perform suitable operations to translate the received instruction. The address calculation block 212 may compute an address based on input received from the decode and rename block 210. The load and store block 213 may receive one more or more data words. A data word may comprise a plurality of binary bits. The load and store block 213 may retrieve or store data words, or data, from or to the D cache 214. The load and store block 213 may utilize an address received from the address calculation block 212. The load and store block 213 may store data in main memory 206, at an address location based on the input received from the address calculation block 212.

The D cache 214 may retrieve or store data from or to the L2 cache 218. The I cache 216 may retrieve or store instructions from or to the L2 cache 218. A processor 202 may cause the L2 cache 218 to retrieve or store data 230 from or to the L3 cache data RAM 204. The data 230 may be stored at an address location based on a corresponding tag 234. The tag 234 may be computed based on an address that was computed by the address calculation block 212. The L2 cache 218 may retrieve or store instructions from or to the L3 cache data RAM 204. The instructions may be stored as data 230 in the L3 cache data RAM 204. A processor 202 may cause the L3 cache to retrieve or store data or instructions from or to the main memory 206. The data or instructions may be retrieved from or stored to a location in the main memory 206 based on an address that was computed by the address calculation block 212.

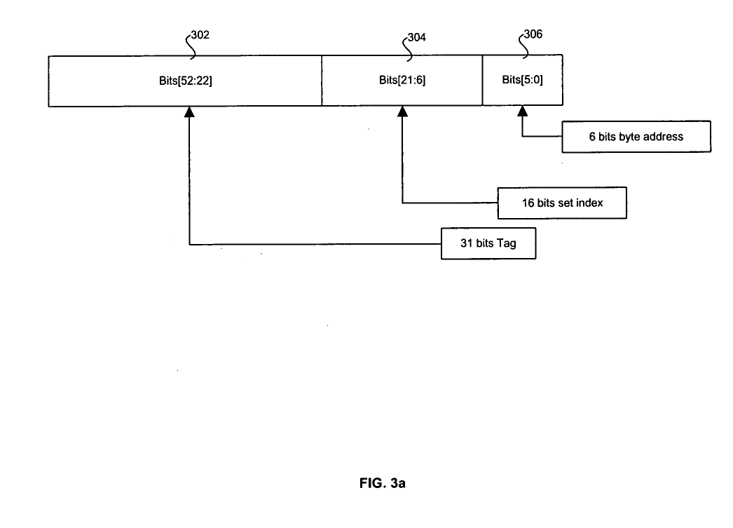

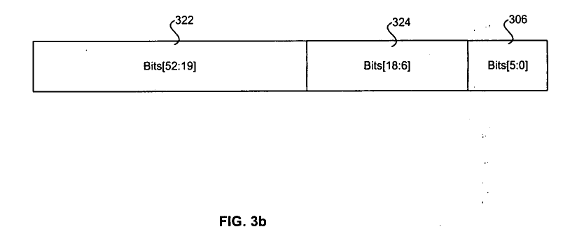

FIG. 3a is a block diagram illustrating an exemplary address structure for addressing data stored in L3 cache memory that may be utilized in connection with an embodiment of the invention. Referring to FIG. 3, there is shown a tag field 302, a set index field 304, and a byte address field 306. The tag field 302 may comprise 31 binary bits, the set field 304 may comprise 16 binary bits, and the word address field 306 may comprise 6 binary bits, for example. The exemplary address structure illustrated in FIG. 3 may comprise an address that may be generated by the address calculation block 212, for example. The address may indicate a location, within main memory 206, at which an instruction or data may be retrieved or stored by the processor 202. In this respect, the exemplary address structure illustrated in FIG. 3, which indicates a location within main memory 206, may be referred to as a physical address.

FIG. 3b is a block diagram illustrating an exemplary address structure for addressing data stored in L2 cache memory that may be utilized in connection with an embodiment of the invention. Referring to FIG. 3b there is shown a tag field 322, a set field 324 and a byte address field 306. A cache line may be retrieved from the L2 cache 218 at a location indicated by an L2 address. An L2 address may comprise a tag field 322 , a set field 324 and a byte address field 306, for example. An L3 address may comprise a tag field 302, set field 304, and a byte address field 306. The L3 address may be utilized to access a location within an L3 cache tag RAM 420, an L3 cache data RAM 404, or the main memory 206. The number of bits contained in the tag field 322 of an L2 address may differ from the number of bits contained in the tag field 302 of an L3 address. The number of bits contained in the set field 324 of an L2 address may differ from the number of bits contained in the set field 304 of an L3 address.

An exemplary L3 cache data RAM 204 may comprise about 32 mega bytes (MB), further comprising a plurality of lines of data 230, wherein each line of data 230 comprises a plurality of bytes. The notation M may represent a value of 2²⁰. A line of data 230 may comprise 64 bytes (B), for example. In this example, the exemplary L3 cache data RAM 230 may comprise a plurality of 32 MB/(64 B per line of data), or about 512K lines of data 230, wherein the notation K line may represent a value of 2¹⁰. If the exemplary L3 cache data RAM 204 comprises an implementation of an 8-way set-associative cache, the 512K lines of data 230 may be further partitioned into 512K lines/(8 lines per set), or about 64K sets. In an 8-way set-associative cache, the tag set 234 may comprise 8 tag fields, for example.

In operation, the address calculation block 212 may generate a physical address. The physical address may comprise a tag field 302, a set field 304, and a byte address field 306. The set field 304 may be utilized to locate a tag set 234 stored within the L3 cache tag RAM 220. The processor 202 may compare the binary value of the tag field 302 to the values of each of the tag fields contained within the tag set 234. A cache hit may be determined if the binary value of the tag field 302 is about equal to the binary value of a selected tag field contained within the tag set 234. If a cache hit is determined, the selected tag field may be utilized to retrieve a corresponding cache line, data 230, stored within the L3 cache data RAM 204. The retrieved cache line may, for example, comprise 64 bytes. The byte address 306 may be utilized to select a single byte within the retrieved cache line. A cache miss may be determined if the binary value of the tag 302 is not about equal to the binary value of all the tag fields contained within the tag set 234. If a cache miss is determined, the physical address may be utilized to retrieve the memory line that contains an accessed data word stored within main memory 206. A data word may comprise a plurality of bytes, for example 8 bytes.

A location associated with a tag set 234 within the L3 cache tag RAM 220 may correspond to a location associated with a cache line within the L3 cache data RAM 204. For example, if a cache hit is determined in connection with a tag set 234, located at a location n within the L3 cache tag RAM 220, the retrieved data word 230 may be located at cache line m within the L3 cache data RAM 204. The cache line m may be one of a plurality of locations within the L3 cache data RAM 204 comprising cache lines n . . . n+N-1, where the variable N is based on an N-way set-associative cache. Consequently, for an exemplary L3 cache data RAM 204 that comprises 512K cache lines, an exemplary L3 cache tag RAM 220 may require a size comprising (31 bits per tag field)×(512K cache lines)/(8 bits per byte), or about 2 MB to store the tag fields for 512K cache lines. For an N-way set-associative cache, each location within the L3 cache tag RAM 220 may comprise a tag set 234 that further comprises 31*N binary bits. A physical address that comprises greater than 53 binary bits, for example 64 binary bits, may comprise a tag field 302, wherein the tag field 302 comprises greater than 31 binary bits. As the tag set 234 size increases, the required size for the L3 cache tag RAM 220 may also increase.

The physical dimensions required to accommodate the L3 cache tag RAM 220 may increase as the corresponding size increases. The physical dimensions required to accommodate a 2 MB L3 cache tag RAM 220, for example, may exceed the physical dimensions that may be allocated within a processor 202. One approach that may be utilized to reduce the size of the L3 cache tag RAM 220 may comprise decreasing the number of bits that are contained within the tag 302. For example, if a 4-way set-associative cache were implemented, the 512K cache lines within the L3 cache data RAM 204 may be partitioned into 128K sets. The cache tag RAM 220, in this case, may comprise 128K tag set 234. The corresponding set field 304 may comprise 17 bits. For a data word 230 that comprises 64 bytes, the byte address 306 may comprise 6 bits. Given a physical address that comprises 53 bits, the tag field 302 may comprise 30 bits. The physical dimensions associated with an L3 cache tag RAM 220 that comprises 512K/8 tag sets 234, wherein each tag set 234 comprises a plurality of four 31 bit tag fields, may be larger than the physical dimensions associated with an L3 cache tag RAM 220 that comprises 512K/4 tag sets 234, wherein each tag set 234 comprises a plurality of four 30 bit tag fields. One shortcoming in this approach is that the 4-way set-associative cache may comprise 4 cache lines per set, in comparison the 8-way set-associative cache that may comprise 8 cache lines per set. The probability of a cache miss may be greater with implementations utilizing a 4-way set-associative cache, than with implementations utilizing an 8-way set-associative cache.

Another approach that may be utilized to reduce the size of the L3 cache tag RAM 220 may utilize sub-block design. In a sub-block design approach, the L1 and/or L2 cache line may comprise 64 bytes, and the L3 cache line may comprise 128 bytes, for example. The L3 cache line may be further divided into a plurality of sub-blocks, for example 2 sub-blocks. Among the plurality of sub-blocks within the L3 cache line, a portion of the sub-blocks may be stored within an L2 cache line. Increasing the cache line size from 64 bytes to 128 bytes in a 32 MB L3 cache data RAM 204 may reduce the number of cache lines from 512K lines to 256K lines, for example. The number of tag sets 234 within the L3 cache tag RAM 220 may be correspondingly reduced from 512K to 256K, for example. The reduction in the number of tag sets 234 within the L3 cache tag RAM 220 may reduce the size associated with the L3 cache tag RAM 220. One shortcoming with this approach is that the portion of the sub-blocks within an L3 cache line that are not stored within the L2 cache line may be wasted. Thus, the sub-block design approach may inefficiently utilize cache memory.

A cache line in an L1 cache, L2 cache 218, or L3 cache data RAM 204 may be of equal length, for example 64 bytes. A physical address, comprising 53 bits for example, may be utilized to locate a cache line in the L1 cache, L2 cache 218, L3 cache data RAM 204, or main memory 206. The physical address may be partitioned into a tag field 302, set field 304, and a byte address field 306, for example. This partition may be referred to as an L3 address. Similarly, the physical address may be represented as an L1 address or L2 address. For example, an L2 address representation may comprise a tag field 322, a set field 324, and the byte address field 306. The number of bits contained in the byte address field may be equal in the L1, L2, or L3 addresses, for example 6 bits. The byte address may be contained in the least significant bits within an L1, L2 or L3 address. The number of bits contained in the set field may differ among the L1, L2, or L3 addresses based upon the size and set-associativity utilized in each of the L1, L2, or L3 caches, respectively. The number of bits contained in the tag field may differ among the L1, L2, or L3 addresses. The total number of bits contained in the tag field and set field may be equal among the respective L1, L2, or L3 addresses. The tag field and the set field may comprise a memory line number. The memory line number may be utilized to access a cache line in the respective L1, L2, or L3 cache.

When the processor 202 issues a request utilizing a physical address, the physical address may be represented as an L1 address when accessing the L1 cache. An L1 memory line number may be derived from the L1 address and utilized to access a corresponding cache line in the L1 cache. If a cache miss occurs, the physical address may be represented as an L2 address. An L2 memory line number may be derived from the L2 address and utilized to access a corresponding cache line in the L2 cache 218. If a cache miss occurs, the physical address may be represented as an L3 address. An L3 memory line may be derived from the L3 address and utilized to access a corresponding cache line in the L3 cache data RAM 204. If a cache miss occurs, the physical address may be utilized to access a location in the main memory 206.

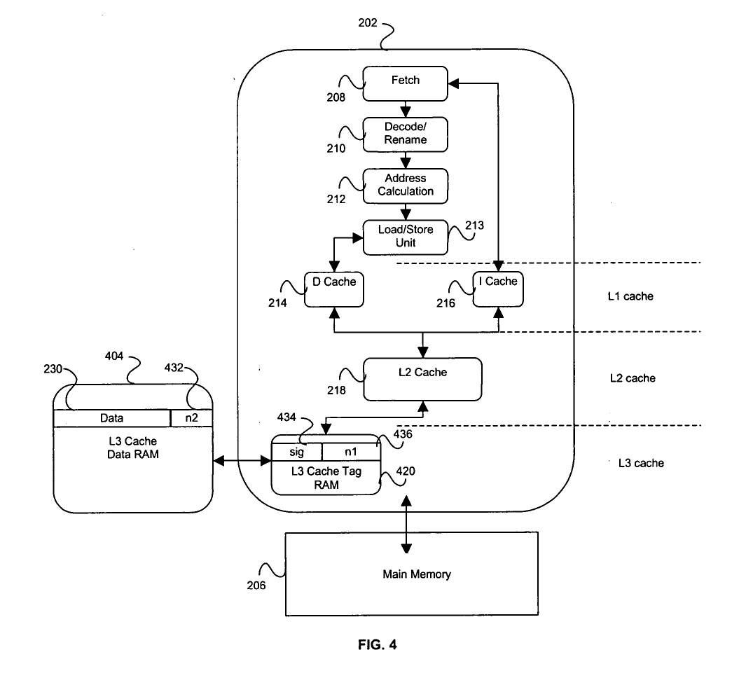

FIG. 4 is a block diagram illustrating an exemplary system for supporting large caches with split and canonicalization tags, in accordance with an embodiment of the invention. Referring to FIG. 4 there is shown a processor integrated circuit (IC) 202, an L3 cache data RAM 204, and main memory 206. The processor IC 202, or processor, may comprise a fetch block 208, a decode and rename block 210, an address calculation block 212, a load and store block 213, a data (D) cache 214, an instruction (I) cache 216, an L2 cache 218, and an L3 cache tag RAM 420. The L3 cache tag RAM 420 may store a plurality of tag signature (sig) fields 434, and tag subfields (n1) 436. The L3 cache data RAM 404 may store a plurality of data fields 230 and tag subfields (n2) 432. A cache line in the L3 cache data RAM 404 may comprise a data field 230 and an n2 subfield 432. A tag field within the tag set 234 may comprise a plurality of tuples (sig, n1) comprising tag subfields sig 434 and n1 436.

FIG. 4 differs from FIG. 2 in that the tag field within the tag set 234 (FIG. 2) is split into tag subfields n2 432 and n1 436. The tag subfield n1 436 may comprise a portion of the binary bits that are contained in the tag field 302. The tag subfield n2 432 may comprise a portion of the binary bits that are contained in the tag field 302. The subfield n2 432 may be stored in a cache line, along with the data 230, at a location within the L3 cache data RAM 404. The subfield n1 436 may be stored, along with the sig field 434, at a location within the L3 cache tag RAM 420. The sig field 434, which represents a canonicalization tag, may be computed based on the tag subfield n2 432.

An exemplary tag field 302, as shown in FIG. 3, may comprise 31 bits. The tag field 302 may be divided and represented as two concatenated subfields, or bit vectors {n2, n1}. For example, the subfield n2 432 may comprise the most significant 23 bits in the tag 234, while the subfield n1 436 may comprise the least significant 8 bits in the tag 234. The bit vector n2 432 may be stored with data 230 in the L3 cache data RAM 404. The splitting of the tag 234 into bit vectors, n1 436 and n2 432 and storing of the portion n1 436 within the L3 cache tag RAM 420, may enable the design of processor ICs 202 wherein the physical dimensions associated with the L3 cache tag RAM 420 may consume less physical area within the processor IC 202 than might be the case if the tag 302 were stored in the L3 cache tag RAM 220. In various embodiments of the invention, the size of the L3 cache tag RAM 420 may be reduced, in comparison to some conventional approaches to cache design, while avoiding some of the shortcomings associated with some conventional approaches to reducing cache size. Consequently, for a given size of the L3 cache tag RAM 420, various embodiments of the invention may comprise a larger number of cache lines within the L3 cache data RAM 404, in comparison to some conventional approaches to cache design. Increasing the number of cache lines within the L3 cache tag RAM 420 may increase the probability that a cache hit will occur during the operation of the processor 202.

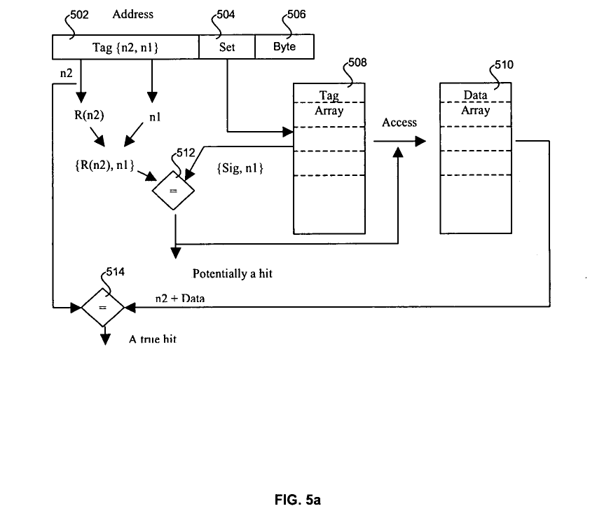

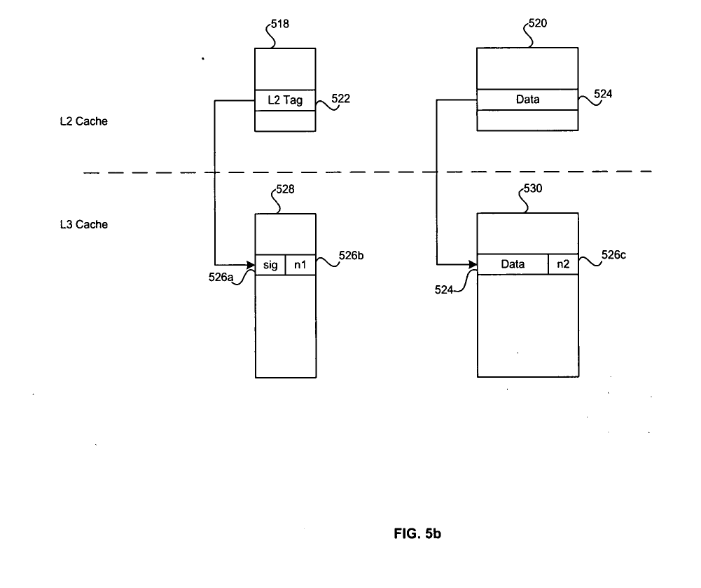

FIG. 5a is a block diagram illustrating an exemplary method for addressing supporting large caches with split and canonicalization tags, in accordance with an embodiment of the invention. Referring to FIG. 5a, there is shown a physical address comprising a tag field 502, a set field 504 and a byte field 506. Also shown in FIG. 5a are a tag array 508, a data array 510, a sig comparator 512, and an n2 comparator 514. The address may represent a physical address. The tag field 502 may comprise bit vectors n1, and n2. The tag array 508 may comprise a plurality of tag sets. Each tag set may comprise a plurality of (sig, n1) tuples that may be stored in the L3 cache tag RAM 420. Each tuple may comprise a tag signature, sig, and a bit vector n1. The data array 510 may comprise a plurality of cache lines. Each cache line may comprise a (n2,data) tuple that may be stored in the L3 cache data RAM 404. The tag array 508, sig comparator 512, and/or n2 comparator 514 may be contained within the processor 202. The physical address may be generated by the address calculation block 212.

When a new cache line is to be installed into the L3 cache tag RAM 420, and/or the L3 cache data RAM 404, a value for the set field 504 may be calculated based on a physical address. A new cache line may be installed into the L3 cache tag RAM 420 and/or the L3 cache data RAM 204 when a cache miss occurs, for example. The set field 504 may indicate a location within the tag array 508. The location within the tag array 508 may comprise a tag set 234. A canonicalization function R(n2) may be utilized to compute a canonicalization tag, sig. The function R( ) may compute the canonicalization tag, sig, based on the value of the bit vector n2. The value of the bit vector n2 may be based on the tag 502. The number of bits contained within the sig may be fewer than the number of bits contained within the bit vector n2. For example, in one embodiment of the invention, the bit vector n1 may comprise 8 bits, the bit vector n2 may comprise 23 bits, and the sig may comprise 8 bits.

A tuple comprising (sig, n1) may be stored at a location within the tag array 508 as indicated by the set field 504. For an N-way set-associative cache, the indicated location may comprise a plurality of N tuples (sig,n1). The value of a bit vector n1 may be based on a tag 502. The tuple (sig, n1) may comprise about 50 percent fewer bits than are contained within the tag 502, for example. As a result, in various embodiments of the invention, the size of the L3 cache tag RAM 420 may be about 50 percent less than the size of an L3 cache tag RAM 220 that utilizes some conventional methods for cache memory allocation. A tuple comprising data 230 and the bit vector n2 432 may be stored at a location within the data array 510 that corresponds to the location within the tag array 508 at which the tuple (sig, n1) was stored.

When a cache lookup operation is performed in the L3 cache tag RAM 420, the processor 202 may generate a physical address comprising a tag 502, a set field 504 and a byte address 506. The address may comprise, for example, a 53 bit physical address. The set field 504 may be determined based on the generated physical address. The set field 504 may be utilized to identify a location within the tag array 508. A plurality of tuples (sig, n1) may be retrieved from the tag array 508 at the identified location. The tag field 502 within the generated physical address 502 may be decomposed into bit vectors n2 and n1. The canonicalization function may be applied utilizing the bit vector n2 to generate a canonicalization tag R(n2). A corresponding tuple (R(n2), n1) may be generated. The sig comparator 512 may compare the binary value of the tuple (R(n2), n1) and the binary value each one of the retrieved plurality of tuples (sig, n1). If the binary values of the tuple (R(n2),n1) and at least one of the retrieved plurality of tuples (sig, n1) are about equal, it may indicate that a potential cache hit has occurred. A tuple (sig, n1), whose binary value is about equal to the binary value of the tuple (R(n2),n1), may be referred to as a potential hit tuple. A potential cache hit may indicate that data, which is stored within the main memory 206 at a location indicated by the generated physical address, may also be stored within cache memory. If the binary values of the tuple (R(n2),n1) are not about equal to any of the retrieved plurality of tuples (sig, n1), this may indicate that a cache miss has occurred. A cache miss may indicate that data, which is stored within the main memory 206 at the location indicated by the generated physical address, may not be stored within cache memory. In the event of a cache miss, the processor 202 may retrieve data from the main memory 206.

In the event of a potential cache hit, a cache line, comprising a tuple (data, n2), may be retrieved from the data array 510 at a location corresponding to the location within the tag array 508 at which a potential hit tuple was retrieved. The n2 comparator 514 may compare the value of the bit vector n2 contained in the retrieved tuple (data, n2), to the value of the bit vector n2 contained in the generated physical address 502. If the respective bit vector values n2 from the retrieved tuple (data, n2) and from the generated physical address 502 are about equal, it may indicate that a cache hit has occurred. If the binary values are not about equal, this may indicate that a cache miss has occurred. A cache miss may indicate that data, which is stored within the main memory 206 at the location indicated by the generated physical address, may not be stored within cache memory. In the event of a cache miss, the processor 202 may retrieve data from the main memory 206.

In various embodiments of the invention, a cache line may be transferred from the L3 cache to the L2 cache, and vice versa. If the operation of writing a cache line to the L3 cache is initiated by the L2 cache, it may also be referred to as a write-back operation. The write-back operation may produce a cache hit within the L3 cache. A cache line may be retrieved from the L2 cache 218 at a location indicated by an L2 address as described in FIG. 3b. During a cache write-back operation the processor 202 may translate an L2 address to an L3 address. An L3 address may be configured as described in FIG. 3a. The fields sig 434, n1 436 and n2 432 may be computed based on the L3 address. Data 230, stored in an L2 cache 218 at a location based on an L2 address, may be transferred to an L3 cache data RAM 402, at a location based on an L3 address.

FIG. 5b is a block diagram illustrating an exemplary cache write-back operation, in accordance with an embodiment of the invention. Referring to FIG. 5b there is shown, a L2 tag array 518, an L2 data array 520, an L3 tag array 528, an L3 data array, an L2 tag 522, an L2 data field 524, a sig field 526a, an n1 subfield 526b, and an n2 subfield 526c. A cache line in the L2 data array 520 may comprise an L2 data field 524. In operation, a write-back operation may occur when an L2 cache may transfer a previously installed cache line from the L2 data array 520 to the L3 data array 530. The L2 address, which indicates the location of the cache line comprising the L2 data field 524 within the L2 data array 520, may be utilized to compute an L3 address. The L3 address may be utilized to compute the sig field 526a, and the n1 526b and n2 526c subfields. The sig field 526a and n1 subfield 526b may be stored in the L3 tag array 528. The data field 524 and the n2 subfield 526c may be stored in the L3 data array 530.

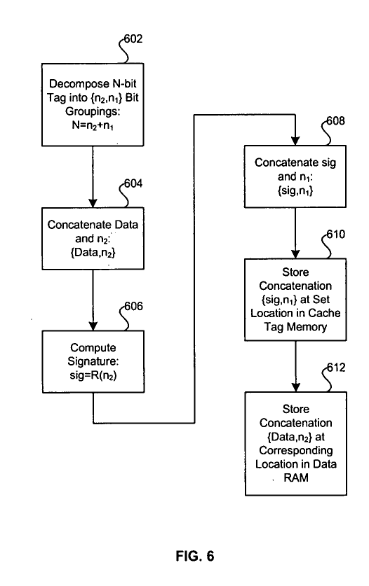

FIG. 6 is a flowchart that illustrates exemplary steps by which a cache line may be written, in accordance with an embodiment of the invention. Referring to FIG. 6, in step 602, an N-bit tag field 502, derived from a physical address, may be decomposed into bit vectors n1 436 and n2 432. The physical address may comprise a tag 502, a set field 504, and a byte address 506. The number of bits N may be equal to the number of bits in the bit vector n1 436 and the number of bits in the bit vector n2 432. In step 604, an L3 cache data RAM 404 cache line may be generated by concatenating bits from data 230 to be stored in the L3 cache data RAM 404, and bits from the bit vector n2 432. In step 606, the canonicalization tag, sig may be computed. The canonicalization tag may be computed by applying a canonicalization function R( ) to the binary value of the bit vector n2 432. In step 608, a concatenated tuple (sig, n1) may be formed by concatenating bits from the canonicalization tag and bits from the bit vector n1 436. In step 610, the concatenated tuple (sig, n1) may be stored at a location within the L3 cache tag RAM 220, as indicated by the set field 504 within the physical address. In step 612, the concatenated tuple (data, n2) may be stored at a corresponding location within the L3 cache data RAM 404.

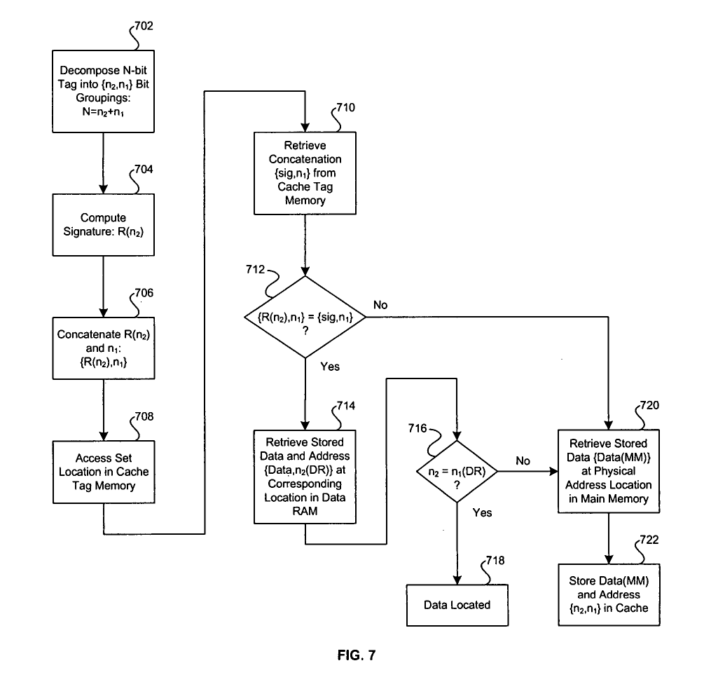

FIG. 7 is a flowchart that illustrates exemplary steps by which a cache line maybe read, in accordance with an embodiment of the invention. Referring to FIG. 7, in step 702 an N-bit tag field 502, derived from a physical address, may be decomposed into bit vectors n1 436 and n2 432. The number of bits in the N-bit tag field 502 may be equal to the sum of the number of bits in the bit vectors n1 436 and n2 432. The physical address may comprise a tag field 502, a set field 504, and a byte address 506. In step 704, a canonicalization value R(n2) may be computed by applying the canonicalization function R( ) to the binary value of the bit vector n2 432. In step 706, bits from the canonicalization value R(n2) and bits from the bit vector n1 436 may be concatenated to form the tuple (R(n2), n1). In step 708, a location within the L3 cache tag RAM 420, as indicated by the set field 504 within the address, may be accessed. In step 710, the concatenated tuple (sig, n1) may be retrieved from the L3 cache tag RAM 420. In step 712, bits from the tuple (R(n2), n1) may be compared to bits from the tuple (sig, n1).

If the bits from the tuples (R(n2), n1) and (sig, n1) are determined to be about equal in step 712, in step 714 a tuple (data, n2(DR)) may be retrieved from the L3 cache data RAM 404 at a location that corresponds to the location at which the tuple (sig, n1) was retrieved from the L3 cache tag RAM 420. The bit vector n2(DR) may refer to a bit vector that may be retrieved from the L3 cache data RAM 404. In step 716, bits from the bit vector n2 may be compared to bits from the bit vector n2(DR). If the bits from the bit vectors n2 and n2(DR) are determined to be about equal in step 716, a cache hit may have occurred and the data may be located in cache memory as indicated in step 718.

If the bits from the bit vectors n2 and n2(DR) are not determined to be about equal in step 716, a cache miss may have occurred. In step 720, data 230 may be retrieved from main memory 206 at a location in main memory 206 as indicated by the physical address. In step 722, the data 230 may be stored the L3 cache data RAM 404. In addition, bit vectors n2 432, and signature sig 434 and n1 436 may be computed based on the physical address and stored in the L3 cache data RAM 404 and in the L3 cache tag RAM 420 respectively.

If the bits from the tuples (R(n2), n1) and (sig, n1) are determined to not be about equal in step 712, a cache miss may have occurred, and step 720 may follow.

Various embodiments of the invention may comprise a system supporting large caches with split and canonicalization tags that may reduce the size of cache memory located within a processor 202 in comparison to some conventional cache designs. This is an important feature with regard to processor design as evaluated in terms of area, power, yield and cost. Many processor designs may comprise high-speed custom circuitry that utilize the most advanced and expensive process technology. Reducing the amount of silicon chip area for tag RAM 220 that is dedicated to maintaining and storing tags is a design objective. By reducing the amount of chip area dedicated to maintaining and storing tags, the die size of the processor IC 202 may be reduced. Reducing the die size of the processor IC 202 may enable the manufacture of a greater number of processor ICs 202 on a single silicon wafer. Furthermore, a smaller die size may reduce the probability of defects, resulting in improved IC yield. Various embodiments of the invention may locate a substantial portion of the tag set 234 in an external (to the processor 202) L3 cache data RAM 404. In contrast to the processor 202 design, RAM may be considered to be a commodity product that is characterized by large volume and low cost. Thus, increases in the cache size may substantially occur within the portion of cache memory that is designed utilizing relatively low cost, commodity components.

A system for accessing stored data may comprise a processor 202 that generates a new tag based on at least a current portion of a tag field 502 of an address. The new tag may also be referred to as a canonicalization tag. The processor 202 may retrieve a data cache line based on the new tag. A portion of the retrieved data cache line may be compared to the current portion of the tag field 502. The processor 202 may determine that a cache hit when at least a portion of the retrieved data cache line is about equal to the current portion of the tag field 502. A cache miss may occur when at least a portion of the retrieved data cache line is not about equal to the current portion of the tag field 502. The processor 202 may retrieve stored data from main memory 206 when the cache miss occurs. A cache hit may occur when the new tag and at least a portion of a retrieved tag set 234 are about equal. The processor 202 may retrieve the data cache line when the cache hit occurs. A cache miss may occur when the new tag is not about equal to any of the retrieved tags within a tag set 234. The processor 202 may retrieve stored data from main memory 206 when the cache miss occurs. The new tag may comprise a plurality of bits that is fewer in number than a corresponding plurality of bits contained within the current portion of the tag field 502. The processor 202 may retrieve a tag set based on a set field 504 portion of the address. The new tag and at least a portion of the tags retrieved within the tag set may be compared. The processor 202 may retrieve the data cache line based on the comparing of the new tag and at least a portion of the retrieved tags.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for accessing stored data, the method comprising:
generating a new tag based on at least a current portion of a tag field of an address; and
retrieving a data cache line based on said new tag.

2. The method according to claim 1, further comprising comparing at least a portion of said retrieved data cache line and said current portion of said tag field.

3. The method according to claim 2, further comprising determining that a cache hit occurs when said at least a portion of said retrieved data cache line is about equal to said current portion of said tag field.

4. The method according to claim 2, further comprising determining that a cache miss occurs when said at least a portion of said retrieved data cache line is not about equal to said current portion of said tag field.

5. The method according to claim 4, further comprising retrieving stored data from main memory when said cache miss occurs.

6. The method according to claim 1, further comprising determining that a cache hit occurs when said new tag and at least a portion of a retrieved tag set are about equal.

7. The method according to claim 6, further comprising retrieving said data cache line when said cache hit occurs.

8. The method according to claim 1, further comprising determining that a cache miss occurs when said new tag and each portion of a retrieved tag set are not about equal.

9. The method according to claim 8, further comprising retrieving stored data from main memory when said cache miss occurs.

10. The method according to claim 1, wherein said new tag comprises a plurality of bits that is fewer in number than a corresponding plurality of bits contained within said current portion of said tag field.

11. The method according to claim 1, further comprising retrieving a tag set based on a set field portion of said address.

12. The method according to claim 11, further comprising comparing said new tag and at least a portion of said retrieved tag set.

13. The method according to claim 12, further comprising retrieving said data cache line based on said comparing said new tag and said at least a portion of said retrieved tag set.

14. A system for accessing stored data, the system comprising:
processor that generates a new tag based on at least a current portion of a tag field of an address; and
said processor retrieves a data cache line based on said new tag.

15. The system according to claim 14, wherein said processor compares at least a portion of said retrieved data cache line and said current portion of said tag field.

16. The system according to claim 15, wherein said processor determines that a cache hit occurs when said at least a portion of said retrieved data cache line is about equal to said current portion of said tag field.

17. The system according to claim 15, wherein said processor determines that a cache miss occurs when said at least a portion of said retrieved data cache line is not about equal to said current portion of said tag field.

18. The system according to claim 17, wherein said processor retrieves stored data from main memory when said cache miss occurs.

19. The system according to claim 14, wherein said processor determines that a cache hit occurs when said new tag and at least a portion of a retrieved tag set are about equal.

20. The system according to claim 19, wherein said processor retrieves said data cache line when said cache hit occurs.

21. The system according to claim 14, wherein said processor determines that a cache miss occurs when said new tag and each portion of a retrieved tag set are not about equal.

22. The system according to claim 21, wherein said processor retrieves stored data from main memory when said cache miss occurs.

23. The system according to claim 14, wherein said new tag comprises a plurality of bits that is fewer in number than a corresponding plurality of bits contained within said current portion of said tag field.

24. The system according to claim 14, wherein said processor retrieves a tag set based on a set field portion of said address.

25. The system according to claim 24, wherein said processor compares said new tag and at least a portion of said retrieved tag set.

26. The system according to claim 25, wherein said processor retrieves said data cache line based on said comparing said new tag and said at least a portion of said retrieved tag set.
